(19) United States
(12) Patent Application Publication
(10) Pub. No.: US 2011/0264311 A1
(43) Pub. Date: Oct. 27, 2011

(54) UNMANNED AERIAL VEHICLE AND METHOD FOR COLLECTING VIDEO USING THE SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/869,768

(22) Filed: Aug. 27, 2010

(30) Foreign Application Priority Data
Apr. 26, 2010 (TW) 99113009

(51) Int. Cl. H04N 7/18; G01C 21/00; B64D 37/00; G05D 1/00

(52) U.S. Cl. 701/15; 348/144; 348/E07.085

(57) ABSTRACT

A method for collecting video using an unmanned aerial vehicle (UAV) captures video upon the condition that the UAV flies along a preset flight path, stores the captured video in a storage device of the UAV, and directs the UAV to land on a relay station upon the condition that the UAV is at a certain longitude and latitude relative to the relay station. The method further refuels the UAV at the relay station, transmits the captured video stored in the storage device to a computer of the relay station, and directs the UAV to fly to a next relay station along the flight path.

### BACKGROUND

1. Technical Field

Embodiments of the present disclosure relate to data collection technology, and particularly to an unmanned aerial vehicle (UAV) and method for collecting video using the UAV.

2. Description of Related Art

UAVs have been used to perform security surveillance by capturing video of a plurality of monitored scenes, and storing the captured video in a storage device of the UAVs. However, because a storage space of the storage device is limited, if a UAV needs to fly a long distance, the storage device of the UAV cannot store all of the video captured by the UAV during the flying process, which may result in lost data, especially when the UAV is damaged during the flying process. Therefore, an efficient method for collecting video using the UAV is desired.

### BRIEF DESCRIPTION OF THE DRAWINGS

FIG. 1 is a schematic diagram of some embodiments of a data collection system.

FIG. 2 is a block diagram of some embodiments of the UAV in FIG. 1.

FIG. 3 is a flowchart of some embodiments of a method for collecting video using the UAV in FIG. 2.

FIG. 4 is a detailed flowchart of some embodiments of block S1 in FIG. 3.

### DETAILED DESCRIPTION

All of the processes described below may be embodied in, and fully automated via, functional code modules executed by one or more general purpose computers or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

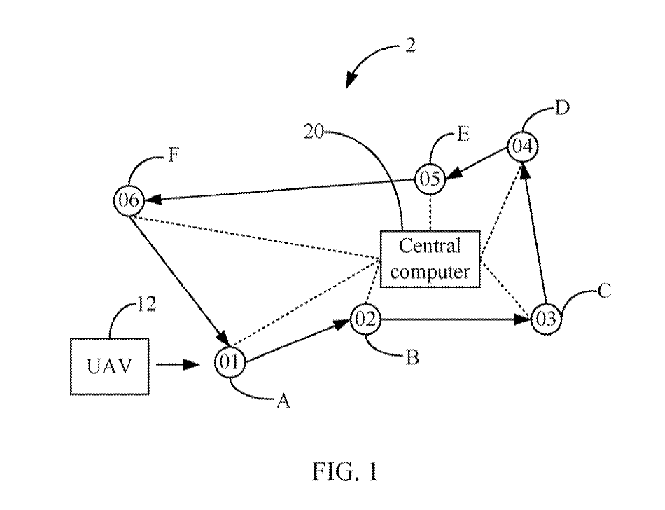

FIG. 1 is a schematic diagram of some embodiments of a data collection system 2. In some embodiments, the data collection system 2 may include an unmanned aerial vehicle (UAV) 12, a central computer 20, and a plurality of relay stations A-F (i.e., 01-06). The relay stations A-F form a flight path (e.g., A→B→C→D→E→F→A), and the relay station A is a start and end point of the flight path.

The central computer 20 may be used to set the flight path of the UAV 12 and a plurality of relay stations for the UAV 12 to land on, along the flight path, and upload the flight path to the UAV 12. Thus, the UAV 12 may fly along the flight path. Each of the relay stations has a known longitude, latitude, and elevation.

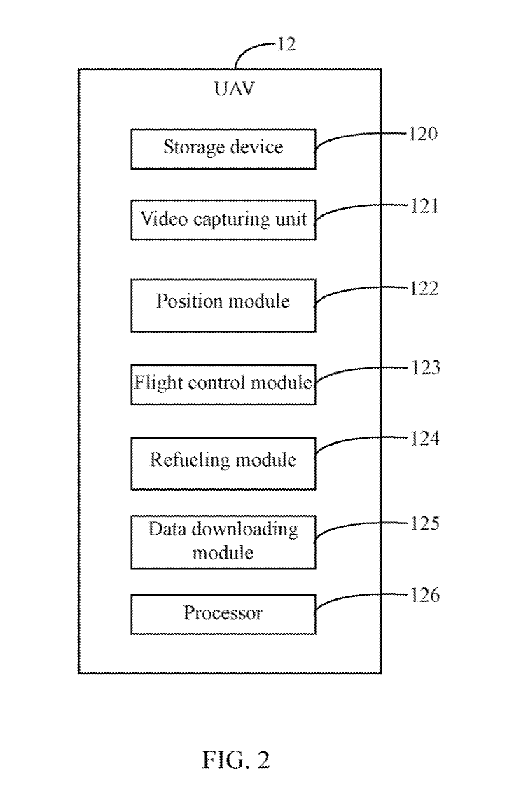

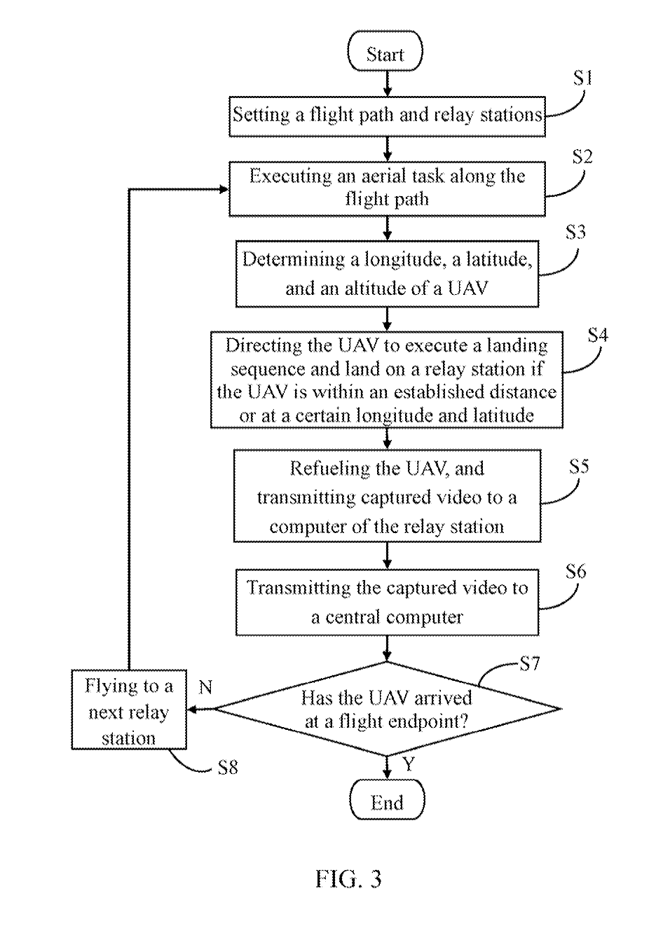

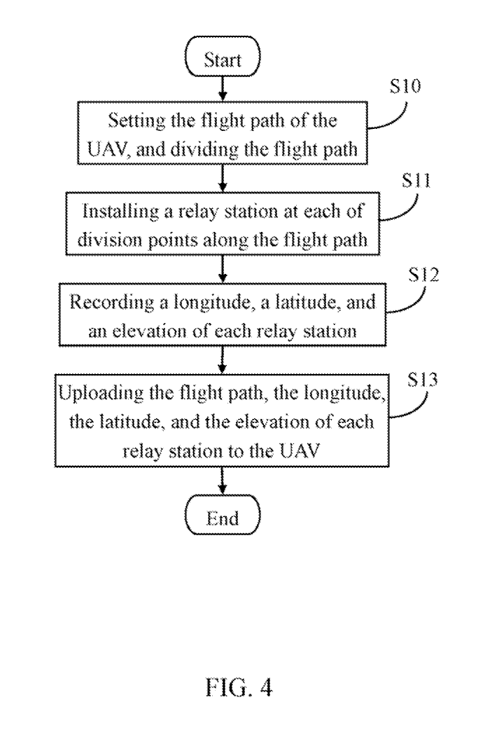

FIG. 2 is a block diagram of some embodiments of the UAV 12. In some embodiments, the UAV 12 includes a storage device 120, a video capturing unit 121, a position module 122, a flight control module 123, a refueling module 124, a data downloading module 125, and a processor 126. In some embodiments, the modules 122-125 comprise one or more computerized instructions that are stored in the storage device 120. The processor 126 executes the computerized instructions to implement one or more operations of the UAV 12. The UAV 12 may be used to collect video, and transmit the collected video to a computer of each of relay stations along the flight path. A detailed description of the function of each of the modules 122-125 is shown in FIG. 3 and FIG. 4.

FIG. 3 is a flowchart of one embodiment of a method for collecting video using the UAV 12. Depending on the embodiment, additional blocks may be added, others removed, and the ordering of the blocks may be changed.

In block S1, the central computer 20 is used to set a flight path of the UAV 12 and a plurality of relay stations for the UAV 12 to land on, along the flight path, and upload the flight path to the UAV 12. Each of the relay stations has a known longitude, latitude, and elevation. In addition, a refueling equipment and a computer are installed at each of the relay stations.

In block S2, the UAV 12 executes an aerial task along the flight path, captures video using the video capturing unit 121, and stores the captured video in the storage device 120. The video capturing unit 121 may include a night vision function.

In block S3, the position module 122 determines or acquires a longitude, a latitude, and an altitude of the UAV 12. The position module 122 determines or acquires the longitude, the latitude, and the altitude of the UAV 12 using a global position system (GPS).

In block S4, the flight control module 123 directs the UAV 12 to execute a landing sequence (e.g., A→B→C→D→E→F→A) and land on a relay station (e.g., the relay station B) upon the condition that the UAV 12 is within an established distance (e.g., A→B) or at a certain longitude and latitude relative to the relay station. In some embodiments, the flight control module 123 directs the UAV 12 to execute the landing sequence and land on the relay station according to a falling distance of the UAV 12, the falling distance of the UAV 12 is equal to a difference value between the altitude of the UAV 12 and the elevation of the relay station.

In block S5, the refueling module 124 controls the refueling equipment at the relay station to refuel the UAV 12. Then, the data downloading module 125 transmits the captured video stored in the storage device 120 to the computer of the relay station, and deletes the captured video in the storage device 120 after the captured video in the storage device 120 has been transmitted to the computer of the relay station.

In block S6, the computer of the relay station transmits the captured video to the central computer 20.

In block S7, the flight control module 123 determines if the UAV 12 has arrived at the flight endpoint (e.g., the relay station A) of the flight path. If the UAV 12 has arrived at the flight endpoint of the flight path, the procedure ends. If the UAV 12 has not arrived at the flight endpoint of the flight path, the procedure goes to block S8.

In block S8, the flight control module 123 directs the UAV 12 to fly to a next relay station (e.g., the relay station C) along the flight path, and then the procedure returns to block S2.

FIG. 4 is a detailed flowchart of one embodiment of block S1 in FIG. 3. Depending on the embodiment, additional blocks may be added, others removed, and the ordering of the blocks may be changed.

In block S10, a user sets the flight path of the UAV 12 using the central computer 20, and divides the flight path into a plurality of division points along the flight path.

In block S11, the user installs a relay station at each of the division points along the flight path. Refueling equipment and a computer may be installed at the relay station, and the relay station may be located on the top of a building or a mountain.

In block S12, the user records a longitude, a latitude, and an elevation of each relay station.

In block S13, the user uploads the flight path, the longitude, the latitude, and the elevation of each relay station to the storage device 120 of the UAV 12.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An unmanned aerial vehicle (UAV), comprising:
a storage device operable to store a flight path and locations of a plurality of relay stations along the flight path at known longitudes, latitudes, and elevations;
a video capturing unit operable to capture video upon the condition that the UAV flies along the flight path, and store the captured video in the storage device;
a position module operable to determine a longitude, a latitude, and an altitude of the UAV;
a flight control module operable to directs the UAV to execute a landing sequence and land on a relay station upon the condition that the UAV is within an established distance or at a certain longitude and latitude relative to the relay station;
a refueling module operable to control a refueling equipment at the relay station to refuel the UAV;
a data downloading module operable to transmit the captured video stored in the storage device to a computer of the relay station; and
the flight control module further operable to direct the UAV to fly to a next relay station along the flight path upon the condition that the UAV has not arrived at a flight endpoint.

2. The unmanned aerial vehicle according to claim 1, wherein the data downloading module is further operable to delete the captured video stored in the storage device after the captured video stored in the storage device has been transmitted to the computer of the relay station.

3. The unmanned aerial vehicle according to claim 1, wherein the video capturing unit comprises a night vision function.

4. The unmanned aerial vehicle according to claim 1, wherein the position module determines the longitude, the latitude, and the altitude of the UAV using a global position system (GPS).

5. The unmanned aerial vehicle according to claim 1, wherein the flight control module directs the UAV to execute a landing sequence and land on the relay station according to a falling distance of the UAV, the falling distance of the UAV being equal to a difference value between the altitude of the UAV and the elevation of the relay station.

6. A method for collecting video using an unmanned aerial vehicle (UAV), comprising:
capturing video using a video capturing unit of the UAV upon the condition that the UAV flies along a preset flight path, and store the captured video in a storage device of the UAV, the flight path being divided into a plurality of relay stations;
determining a longitude, a latitude, and a altitude of the UAV;
directing the UAV to execute a landing sequence and land on a relay station upon the condition that the UAV is within an established distance or at a certain longitude and latitude relative to the relay station;
controlling a refueling equipment at the relay station to refuel the UAV, and transmitting the captured video stored in the storage device to a computer of the relay station; and
directing the UAV to fly to a next relay station along the flight path upon the condition that the UAV has not arrived at a flight endpoint.

7. The method according to claim 6, further comprising: transmitting the captured video from the computer of the relay station to a central computer.

8. The method according to claim 6, further comprising: deleting the captured video stored in the storage device of the UAV after the captured video stored in the storage device of the UAV has been transmitted to the computer of the relay station.

9. The method according to claim 6, wherein the step of directing the UAV to execute a landing sequence and land on the relay station according to a falling distance of the UAV, the falling distance of the UAV being equal to a difference value between the altitude of the UAV and the elevation of the relay station.

10. The method according to claim 6, further comprising: setting a flight path of the UAV and a plurality of relay stations along the flight path using a central computer.

11. The method according to claim 10, wherein the step of setting a flight path of the UAV and a plurality of relay stations along the flight path using a central computer comprises:
setting the flight path of the UAV, and dividing the flight path into a plurality of division points along the flight path;
installing a relay station at each of the division points along the flight path, the relay station comprising a refueling equipment and a computer;
recording a longitude, a latitude, and an elevation of each relay station; and
uploading the flight path, the longitude, the latitude, and the elevation of each relay station to the UAV.

12. A non-transitory storage medium having stored thereon instructions that, when executed by a processor of an unmanned aerial vehicle (UAV), causes the processor to perform a method for collecting video using the UAV, the method comprising:
capturing video using a video capturing unit of the UAV upon the condition that the UAV flies along a preset flight path, and store the captured video in a storage device of the UAV, the flight path being divided into a plurality of relay stations;
determining a longitude, a latitude, and an altitude of the UAV;
directing the UAV to execute a landing sequence and land on a relay station upon the condition that the UAV is within an established distance or at a certain longitude and latitude relative to the relay station;
controlling a refueling equipment at the relay station to refuel the UAV, and transmitting the captured video stored in the storage device to a computer of the relay station; and
directing the UAV to fly to a next relay station along the flight path upon the condition that the UAV has not arrived at a flight endpoint.

13. The non-transitory storage medium according to claim 12, further comprising: transmitting the captured video from the computer of the relay station to a central computer.

14. The non-transitory storage medium according to claim 12, further comprising: deleting the captured video stored in the storage device of the UAV after the captured video stored in the storage device of the UAV has been transmitted to the computer of the relay station.

15. The non-transitory storage medium according to claim 12, wherein the step of directing the UAV to execute a landing sequence and land on the relay station according to a falling distance of the UAV, the falling distance of the UAV being equal to a difference value between the altitude of the UAV and the elevation of the relay station.

16. The non-transitory storage medium according to claim 12, further comprising: setting a flight path of the UAV and a plurality of relay stations along the flight path using a central computer.

17. The non-transitory storage medium according to claim 16, wherein the step of setting a flight path of the UAV and a plurality of relay stations along the flight path using a central computer comprises:
setting the flight path of the UAV, and dividing the flight path into a plurality of division points along the flight path;
installing a relay station at each of the division points along the flight path, the relay station comprising a refueling equipment and a computer;
recording a longitude, a latitude, and an elevation of each relay station; and
uploading the flight path, the longitude, the latitude, and the elevation of each relay station to the UAV.

18. The non-transitory storage medium according to claim 12, wherein the medium is selected from the group consisting of a hard disk drive, a compact disc, a digital video disc, and a tape drive.
